(19) United States
(12) Patent Application Publication
(10) Pub. No.: US 2005/0031875 A1
(43) Pub. Date: Feb. 10, 2005

(54) Additives for the manufacture of glass

(75) Inventor: David Pickard, North Yorkshire (GB)

Correspondence Address: STEVENS DAVIS MILLER & MOSHER, LLP, 1615 L STREET, NW, SUITE 850, WASHINGTON, DC, 20036, US

(73) Assignee: Norfeed UK Limited, Boroughbridge (GB)

(21) Appl. No.: 10/490,045

(22) PCT Filed: Sep. 19, 2002
(86) PCT No.: PCT/GB02/04266

(30) Foreign Application Priority Data
Sep. 21, 2001 (GB) 0122788.3

(51) Int. Cl. C03B 5/16; B32B 17/06

(52) U.S. Cl. 428/426; 65/135.9; 65/134.3

(57) ABSTRACT

A glass additive composition which consists of a carrier such as calcium carbonate, having an active material such as zinc selenite in combination with a surfactant and/or film forming material deposited thereon is an effective medium for introducing active materials into the glass manufacturing process and especially the manufacture of container glass.

### FIELD OF THE INVENTION

This invention relates to additive compositions for use in the manufacture of glass, to methods for their preparation and to glass manufacturing processes using such additives.

### BACKGROUND OF THE INVENTION

In the manufacture of glass, batch materials such as sand, soda ash, and limestone etc are combined with various additives such as colorants or decolorisers, and subjected to extremely high temperatures to melt the materials. During this high temperature melting process, a portion of some of the solid materials volatilise when being converted to the glassy liquid state. Such volatilised materials may exit out through the furnace exhaust system with other gases and hence are essentially lost from the glass melt. Apart from being volatilised, the additives may also be lost from the process in particulate form as dust, which is blown through and from the furnace during the process.

This unwanted removal of additive material, which is a vital part of the final glass product, requires that excess quantities of the additive material must be included in the batch to ensure that the final product contains the desired amount of the additive.

The unwanted loss of additive materials in this fashion leads to increased raw material costs in glass manufacture. In addition extra expense may be incurred, as it may be necessary to prevent additive materials from the furnace exhaust being emitted into the atmosphere. Also, many additive materials in their volatile form are corrosive to certain refractory materials used in the glass manufacturing process. Therefore, it is desirable to improve the retention of additive materials within the glass manufacturing process and the final product.

An example of one highly volatile component employed in some glass compositions, such as container glass manufacture, is selenium, which is often used in combination with cobalt as a decolouriser. When selenium is added to the glass batch as elemental selenium, about 75 to 80% is converted to the gaseous state and hence essentially 75-80% of the added selenium is vaporised out of the glass batch and is lost as dust or fume.

The loss of up to 80% of any additive material represents a significant waste of an expensive raw material in the process. In addition some additive materials in their volatile form may be toxic e.g. selenium, and any loss from the process presents a potential hazard to human and animal health. Because the exact loss from the process is not accurately predictable, it may also be difficult to maintain the quality of the glass and control the relative ratios of additive components, such as for example the ratio of selenium to cobalt, in the final glass product, this is therefore an inefficient process.

Various approaches have been used in the art to overcome the problems of retention of volatile additives such as selenium during glass manufacture. One approach is the utilisation of glass frits or agglomerates which contain high levels of the volatile additive in an amorphous (glassy) state which makes it more difficult for any volatile components to leave the glass batch composition during melt processing. This approach has been proposed in WO96/07621, GB 1,036,477, U.S. Pat. No. 2,955,948, U.S. Pat. No. 3,291,585, and U.S. Pat. No. 3,628,932. Another approach proposed in the art is the use of encapsulation as described in EP 0 618 177 A1.

Many processes using selenium as a colorant/decolourant have also included sodium nitrate or potassium nitrate in the batch mixture to help improve the retention of selenium in the final product or for other purposes. For example, U.S. Pat. Nos. 3,296,004; 4,101,705; 4,104,076; and 4,190,452 all disclose bronze glass compositions using selenium together with sodium or potassium nitrates as components of their glass batches.

U.S. Pat. No. 4,104,076 teaches the addition of selenium and nitrates to the batch to make a grey glass composition as well as a bronze glass composition. U.S. Pat. No. 5,070,048 teaches a blue coloured glass product made using selenium together with sodium nitrate in the batch mixture. U.S. Pat. Nos. 4,339,541; 4,873,206; 5,023,210; 5,308,805; 5,346,867; 5,411,922; and 5,521,128 all teach the use of sodium or potassium nitrate in the batch when selenium is used as a colorant to make grey glass products. Hence, as seen from the above, it is extremely common in the glass making industry to include nitrates when using selenium as a colorant.

In the context of coloured glass, other approaches to reduce the use of nitrates have utilised oxidising agents and reducing agents to improve selenium retention such as described in GB 2,260,978 or alternatively manganese oxide as described in U.S. Pat. No. 5, 346,867 and WO99/29634.

Selenium has been utilised in many forms for the manufacture of glass. Elemental selenium occurs in two forms, the red form being converted to the grey form at 130° C. The grey form of selenium melts at 217° C. and boils at 688° C. Under glass melt conditions, which may be as high as 1450° C., selenium is converted to oxygen compounds and polyselenides and may be present in a number of oxidation states as the selenide, selenate or selenite. In view of the volatility of elemental selenium other compounds of selenium with higher melting and/or boiling points have been proposed. One such class of selenium compounds are the selenites, including sodium selenite, calcium selenite, barium selenite, magnesium selenite and zinc selenite. However, these selenite materials are difficult to handle and control during glass manufacture. Sodium selenite is hygroscopic and cakes on storage making it difficult to produce homogeneous mixtures for processing. A further problem with selenite salts is that soluble salts are more harmful compared to selenium metal due to their solubility. In addition selenium salts have a small particle size, which increases losses during use in the exhaust from the process as particulate dust.

Many forms of selenium and cobalt, as used in the glass manufacturing process, exhibit a propensity to form dust. All components of particulate blends have a propensity to form dust. This propensity will depend on: the magnitude of the force applied to the mixture; the physical characteristics of each component, of which, particle size, particle shape, electrostatic properties, particle surface profile and moisture content, are particularly important; and the physicochemical interactions that occur between the individual particles of the different components of the mixture. Additive materials may be emitted from blends in dust and the levels of the additive material in the dust may be lower or higher than the level in the original processing mass. To describe this phenomenon the term Propensity to Dust (PD) is used and is broadly defined as follows:
PD=(% component in the dust)+(% component in the processing mass)

Dust emissions can be determined by a number of methods well known in the art, such as the method devised by Stauber using the Heubach Dustmeter (Ref. Fresenius Z. Anal. Chem.(1984), 318, 522-524, the whole contents of which is hereby incorporated by reference). Ideally one would wish to provide formulations which reduce the propensity to dust for important or hazardous components. The formation of dust is hazardous and also contributes to the loss of these additives from the glass making process as dust emissions.

Apart from the volatilisation of glass additives, a further problem is often observed in the manufacture of the glass batch. This is the problem of segregation or classification within the batch, which occurs during its manufacture and/or introduction to the furnace. The various components used in the manufacture of glass batches may have significantly varying particle sizes, particle size distributions, particle shapes, densities and surface characteristics. This relatively wide variation in particle properties often results in segregation making it difficult to produce glass batches of uniform composition for introduction into the furnace. This segregation may occur as the batch materials are transferred around the glass manufacturing plant. It may also occur during the actual point of feeding the glass batch material into the process as vibration feeders are often used at this stage.

An additional problem occurs on introduction of the batch to the glass furnace; particles of material maybe purged from the batch before it enters the glass melt. This purging effect is due to the action of hot air, which is blown through the glass furnace and out to exhaust, selectively removing smaller particles and low-density particles from the batch as it is being introduced to the process. The overall effect is that significant quantities of additive materials may be removed from the process in this way and be lost in the exhaust.

A further difficulty is observed when attempts are made to introduce low levels of an additive into the glass manufacturing process. It is sometimes difficult or almost impossible to introduce the additive into the process in a controlled fashion to ensure uniformity in the glass batch or uniformity of the finished product. This is especially difficult when automated weighing systems are used. The dosing of selenium/cobalt is not generally a problem as the combination is introduced as a premix. However, the problem may be acute when a single additive such as cerium is added to the process, partly because cerium needs to be added in relatively small quantities.

Selenium is such a strong colourant that it has been used in glass compositions at concentrations as low as 0.0002 to 0.0035 weight % to impart a strong absorption in the spectral transmission between 400 and 500 nanometres. Such low levels are difficult to meter accurately into the glass manufacturing process. The additive composition of the present invention is an effective form for introducing selenium into a glass manufacturing process in a controlled manner.

An object of the present invention is to provide a new means of introducing additive materials often as trace inclusions into the glass manufacturing process. This is achieved by the use of an additive composition that enables the more effective introduction of additive materials into the glass manufacturing process and more especially into a process for the manufacture of container glass.

The present invention seeks to reduce the problem of segregation when introducing additive materials into glass batches and/or the problem of the loss of these additive materials through volatilisation or dust formation during the glass manufacturing process. The present invention also provides a means of introducing additives to the glass manufacturing process in a controlled and effective manner.

### SUMMARY OF THE INVENTION

The present invention therefore in a first aspect provides a particulate glass additive composition comprising at least one particulate carrier and, deposited on the surface of the carrier or carriers, at least one glass additive material in combination with a matrix, the matrix comprising at least one surface-active agent or at least one organic film forming material or mixtures thereof.

In a second aspect the present invention provides a process for the manufacture of a particulate glass additive composition which process comprises contacting at least one particulate carrier with at least one glass additive material to provide a coated carrier followed by contact of the coated carrier with one or more surface-active agents or one or more organic film forming materials or mixtures thereof to form a matrix.

In a third aspect the present invention provides a process for the manufacture of a particulate glass additive composition which process comprises mixing at least one glass additive material with one or more surface-active agents or one or more organic film forming materials or mixtures thereof to form a mixture, followed by contacting of the mixture with one or more particulate carriers to form a coating of the mixture thereon.

In a fourth aspect the present invention provides a process for the manufacture of a particulate glass additive composition which process comprises contacting at least one particulate carrier one or more surface-active agents or one or more organic film forming materials or mixtures thereof to provide a treated carrier followed by contacting of the treated carrier with one or more glass additive materials.

In each of the aspects two to four the process steps may be repeated to build up the amount of glass additive material incorporated into the particulate glass additive composition.

In a fifth aspect the present invention provides a process for the manufacture of glass which process comprises introducing at least one particulate glass additive composition according to the invention into glass forming components to form a glass batch before introduction to a melting furnace or which process comprises introduction of at least one particulate glass additive composition according to the invention directly into the melting furnace during molten glass formation.

### DETAILED DESCRIPTION OF THE INVENTION

The present invention provides a new form of additive composition for the introduction of various elements, compounds or materials into the glass manufacturing process. The additive composition has a specific formulation of components and specific methods of manufacture, which enables the additive composition to be the effective means of introducing additive materials to the glass manufacturing process. The composition has as its key elements a particulate carrier, an additive material, and a surface-active agent and/or organic film forming material.

The particulate carrier may be organic or inorganic and may have any physical shape; it is preferred that it is substantially spheroid in shape. When the carrier is organic it may be derived from synthetic organic materials such as organic hydrocarbon polymers or it may be derived from natural organic materials such as corn-cobs or hazelnut shells. It is preferred that the organic particulate carrier is a granular particulate material derived from an organic polymer. The organic material must be such that it is consumed e.g. via oxidation, under glass manufacturing conditions so that substantially no residue of the organic material remains in the finished glass product. A residue may be tolerated if it does not significantly detract from the quality of the glass product.

In a preferred embodiment the particulate carrier is an inorganic material. The particulate inorganic carrier may be any inorganic material, which is compatible with the glass manufacturing process. It maybe a material that is a major pre-cursor for the final glass product and is therefore consumed in the process in order to form the glass. The inorganic carrier may be a material that, whilst not being consumed to form glass, has substantially no detrimental effect on the physical properties of the final glass product. Non-limiting examples of suitable inorganic materials when in particulate form include lead oxide, zinc oxide, boron oxide, sulphates, fluorides, chlorides, bromides, iodides, phosphates, calcium carbonate, and suitable mixtures thereof. A further suitable carrier is ground glass. A preferred particulate inorganic carrier is calcium carbonate. One example of suitable calcium carbonate is Longcliffe Calcium Carbonate P10 which is obtained from very high purity carboniferous limestone; this material has a moisture content of <0.1 wt %, a specific surface area of greater than 0.2 m²g⁻¹ (typically 0.24 m²g⁻¹) and a particle size (at least 97%) within the range 0.6 to 1.7 mm. Other examples of suitable calcium carbonates include Trucal 14® and Trucal 25® manufactured by Tarmac Central Ltd; both of these materials have low water contents of less than 0.05 wt % and particle size (at least 99%) within the range 75 um to 2.36 mm. It is important that at least 98 wt % of the material has a particle size of 150 um or greater. In the case of Trucal 14® only 0.9 wt % of the material has a particle size below 600 um. It is preferred that the maximum particle size is 4.5 mm. It is preferred that when the additive composition is for use in tank furnaces that 1 wt % or less of the calcium carbonate in the additive is of particle size 3.35 mm or above. When the additive composition is to be used in a pot furnace it is preferred that there are no particles greater than 3.35 mm and that 5 wt % or less are of particle size greater than 1 mm.

The preferred chemical composition of the calcium carbonate is as follows: the calcium content expressed as calcium oxide, CaO, is preferably not less than 55.2 wt % (this is equivalent to a calcium carbonate purity of 98.5 wt %); the total iron content expressed as ferric oxide (Fe₂O₃) should preferably not exceed 0.035 wt %; the total non-volatile matter insoluble in hydrochloric acid should preferably not exceed 1.0 wt %; the organic matter should preferably not exceed 0.1 wt %; and the colouring elements, other than iron, should preferably not be present to an extent sufficient to produce a colour in the glass.

The mass, size, shape and surface properties of the particulate carrier are selected to be compatible with the glass additive material or materials to be used, the surface-active agent or agents to be used and the glass manufacturing process. The particulate carrier must have the required physico-chemical characteristics to ensure that any particular combination of additive and surfactant is retained on its surface. Important characteristics to be considered include its electrostatic character, its surface morphology and its hydrophobic/hydrophilic balance. Thus, for certain additive materials it may be necessary to select a particulate with a certain surface charge to ensure that the additive material is attracted to the carrier surface during preparation of the additive composition. Also, a particulate carrier with a high surface area may be beneficial in achieving a high loading of additive material, when required, on the surface of the carrier. It is preferred that the particle size of the carrier is 150 microns or greater.

The glass additive material used in the manufacture of the additive composition of the present invention may comprise one or more materials that are added to the glass formulation in addition to the normal bulk components in order to modify the properties of the basic glass composition. The bulk components often used in the preparation of a glass batch, and which are key components of the finished glass itself, are not generally additive materials according to the present invention. These bulk components include network formers, intermediates, network modifiers, and cutlet; these materials are described in detail in “Raw Materials for Glass Making—A Review”, F. G. West-Oram, Glass Technology, Vol 20, No. 6, December 1979, pages 222-245. Examples of these bulk components include silica, sodium oxide, calcium oxide, magnesium oxide and alumina.

The glass additive materials are typically utilised as minor components of the glass and often as a trace addition to the glass manufacturing process. Typical examples of such additives include materials that are incorporated at low levels to modify the colour of the glass; these materials are often referred to as colourants or decolourants. These materials should be distinguished from primary colouring bodies, which are used to introduce and impart the primary colouring agents for glasses and enamels. Other additive materials include oxidants, reducing agents, nucleation catalysts, accelerating and refining agents. They may also include materials normally designated as bulk materials but which for some forms of glass are introduced as a minor or trace component of the glass. These materials are described in detail in “Raw Materials for Glass Making—A Review”, F. G. West-Oram, Glass Technology, Vol 20, No. 6, December 1979, pages 222-245.

The glass additive material may be a material that is not normally used in the manufacture of glass or may be in a form that is not typically used in glass manufacture. Thus, the additive material may be a non-typical chemical source of one or more elements that are beneficial in glass manufacture. In this context the additive composition and process of the present invention is particularly effective in enabling difficult to handle materials, such as hygroscopic materials, to be used as the additive material.

It is preferred that the additive material has a melting point of 200° C. or greater. The additive composition and process of the present invention are of particular benefit when used to introduce sources of decolourising agents such as selenium into the glass manufacturing process. Thus selenium as additive material may be utilised in the process of the present invention as the metal element or as a compound of selenium. Suitable compounds of selenium include the selenides, polyselenides, selenites, or selenates. Examples of suitable selenites include sodium selenite, calcium selenite, barium selenite, magnesium selenite and zinc selenite. It is most preferred that the additive material comprises one or more sources of selenium and more preferably comprises at least one selenite and most preferably comprises zinc or sodium selenite. It is preferred that the selenite has low levels of iron that is less than 200 ppm. More preferably the iron content is 50 ppm or less and most preferably 20 ppm or less. One particularly suitable selenite is zinc selenite with an iron content of 10 ppm or less. Examples of such zinc selenites are Zinc Selenite Type I (300 um) and Type II (150 um) manufactured by Retorte (Ulrich Scharrer GmbH). Both of these materials contain at least 41 wt % selenium.

In addition the additive composition and process of the present invention is also effective for the introduction of cobalt into glass manufacturing processes. Cobalt is often used in combination with selenium as decolourising agent for container glass or flint glass manufacture. Selenium is an important additive to correct for the negative effects of Fe in the glass. In these processes the quantity of cobalt required is linked to the amount of selenium introduced into the glass melt. Thus both the required amounts of selenium and cobalt are dependent directly or indirectly on the trace element concentrations of materials such as Fe. When cobalt compounds are included in the additive composition of the present invention in combination with the selenium on the same particulate, it is possible to more accurately and effectively control the combined amounts of selenium and cobalt as required to achieve the optimum decolorisation of the finished glass. Thus in a further aspect the processes for the manufacture of additive compositions according to the second, third and fourth aspects further include the addition of a source of cobalt. This addition may occur at the same time as the selenium or at a different stage of the process. It is possible to prepare the selenium based additive composition and the cobalt based additive composition separately and then to combine the two additive compositions to provide a formulated composition. The preferred form of cobalt is the black oxide (70 to 72% cobalt). Other preferred additive materials or co-additive materials include compounds of Ce, especially Ce³⁺, Cr, Ag, Au, As, Mn, Cu, Sb, Fe, Ti, S, Cd, Ni, Te, Ge and the Rare Earths (lanthanides). Manganese compounds may be usefully incorporated into the additive composition comprising selenium to enable the use of lower levels of selenium. Non-limiting examples of additive materials include CO₃O₄, CU₂O, CuO, Mn₂O₃, NiO, Cr₂O₃, V₂O₃, MoO₃, MnO, TiO₂, CeO₂, Na₂S, CdS, UO₃, CdS, Sb₂S₃, and CO₃O₄.

The additive material may be used in any form that is compatible with the processes used for manufacture of the additive composition. Thus it may be utilised in the form of a liquid, solution, dispersion, or in solid particulate form. It is preferred that the additive material is used in the solid particulate form. In this form it is preferred that the particle size is as small as possible and is in any event less than 300 microns. When the additive material is cobalt oxide it is preferred that 100% of the particles have a particle size of less than 200 microns. When the additive material is a selenite e.g zinc selenite, it is preferred that the particle size is less than 300 micron and more preferably less than 200 micron. In a preferred embodiment the zinc selenite has a particle size distribution as follows: 100% of the particles are of particle size of less than 300 micron, 98% of particle size of less than 150 micron, 90% of particle size of less than 75 micron and 70% of particle size less than 45 micron. It is preferred that the additive material has at least 70% of the particles of particle size less than 100 micron, more preferably less than 75 micron and most preferably less than 50 micron.

The surface-active agent may be any surface-active agent that is compatible with the carrier, the additive material and the glass manufacturing process. It effectively binds or holds the additive material onto the surface of the carrier. Suitable surface-active agents include non-ionic surfactants, anionic-surfactants and cationic-surfactants. Suitable non-ionic surface agents include monoesters of propyleneglycol and of the food fatty acids, stearyl-2-lactylic acid, acetic, lactic, citric, tartaric and monoacetyltartaric esters of the mono and diglycerides of food fatty acids, glycerin polyethyleneglycol ricinoleate, polyethyleneglycol esters of soybean oil fatty acids, sorbitan monostearate sorbitan tristearate, sorbitan monolaurate, sorbitan monooleate, sorbitan monopalmitate and propyleneglycol alginate. Mixtures of these surface-active agents with polyethyleneglycol and/or with propyleneglycol and/or with glycerin can also be used. One example of a suitable surfactant combination is 10 parts Polysorbate 20 (Tween 20®) and 1 part polyethyleneglycol 300. Other suitable surfactants include Cremophor EL® which is a polyoxyethylenglyceroltriricinoleat 35 (DAC) and is manufactured by BASF.

In place of or in addition to the surfactant is used an organic film forming material. Preferably this is an organic polymer which as part of the matrix. It is preferably a thin layer of water-soluble or water-dispersable preferably non-toxic polymer which forms a film at a temperature less than 60° C.

The use of this organic film forming material and/or surfactant ensures that the glass additive material remains in contact with and bound to the carrier material and has no possibility of separating from the carrier and coming into contact with other components of the glass mixture during the subsequent processing in the glass manufacturing process.

Polymers suitable as the organic film forming material include for example cellulose derivatives such as: methylcellulose, hydroxypropylcellulose, methylhydroxypropylcellulose, hydroxypropylmethylcellulose (HPMC), cellulose acetate phthalate (CAP), carboxymethylcellulose, ethylcellulose and acetylcellulose, Hydroxypropylethylcellulose (HPEC) and mixtures of microcrystalline cellulose and carrageenan), vinyl polymers (polyvinylpyrrolidone, polyvinyl alcohol and polyvinylacetate), gum arabic, substances of wax type such as polyethyleneglycols, higher alcohols, higher fatty acids and hydrogenated fatty substances. Other suitable materials include xantham gum, dextrins and maltodextrins.

Preferably the surface-active agent and or organic film forming material is present in a quantity of between 1 and 10% by weight with respect to the combined weight of the carrier and additive material, more preferably 2 and 8%.

The choice of surface-active agent and/or film forming material is based on the hydrophilic and/or lipophilic characteristics of the carrier and/or the additive material. They may be introduced into the process by spraying, pouring, or dripping. Some surface-active agents may be solids or waxy materials under ambient conditions; these may be introduced to the process as a melt to the solid mixture of carrier and additive material. If the solid mixture is cooler than then melted surfactant then this will assist in solidifying the surface-active agent on the surface of the carrier coated with additive material. Alternatively, the mixture may be cooled after addition of the surfactant melt to ensure solidification on the carrier surface. It is also possible to introduce the surface-active agent to the mixture in the solid form and to induce melting of the surfactant in situ under the mixing conditions used. In one embodiment the surface-active agent is applied by spraying into the solid mixture of carrier and additive material whilst this solid mixture is under mixing conditions.

The additive material especially when in the form of a particulate may be applied to the carrier by mixing in a solids mixer. The quantity of applied additive is between 1 and 80%, preferably between 1 and 60%, and most preferably between 1 and 45% by weight with respect to the weight of carrier and surfactant. More preferably it is within the range of 2 to 10% by weight with respect to the combined weight of carrier and surfactant. This is the preferred range especially when the additive material is a selenite such as sodium or zinc selenite. When the additive material is manganese oxide the preferred range is 1 to 40 wt %. When the carrier is calcium carbonate and the additive material is zinc selenite it is preferred that the quantity of additive is within the range 1 to 30% by weight the combined weight of carrier and surfactant. The amount of selenite is selected to provide the required level of selenium in the final additive composition. Preferably the amount of active additive e.g. selenium and/or cobalt, present in the final additive composition is within the range of 0.25 to 35% and more preferably within the range of 1 to 20% and most preferably within the range of 2 to 15% by weight based on the total weight of the additive composition.

In a preferred embodiment the glass additive composition is provided in a glass batch composition which comprises in addition to the additive one or more glass precursor materials.

The process as described in the third aspect of the present invention is the preferred process for the manufacture of the glass additive composition of the present invention and generally consists of the following steps. Firstly, the requisite amount of carrier is introduced into a mixing vessel. Then the requisite amount of surfactant composition is added to the carrier material in the mixing vessel with continuous or intermittent mixing, preferably with continuous mixing, until an even fluid dispersion is obtained. Once this even dispersion is obtained the requisite amount of particulate additive material is introduced to the mixing vessel in stages with continued mixing. As the particulate additive material is introduced the mixture gradually takes on the form of granules. This granulated product is the additive composition of the present invention.

For some formulation it is beneficial to include an oil into the process; this may assist in the granule formation and ensure that all of the additive material is incorporated into the matrix on the carrier. Examples of a suitable oil include mineral oils, white oil, vegetable oil and spreading oils.

In addition a flow aid may also be added to the mixture. If the granule has a relatively high content of water the flow aid assists with the mixing and processing and aids the flow properties of the granulated mixture. One suitable flow aid is hydrophobic silica.

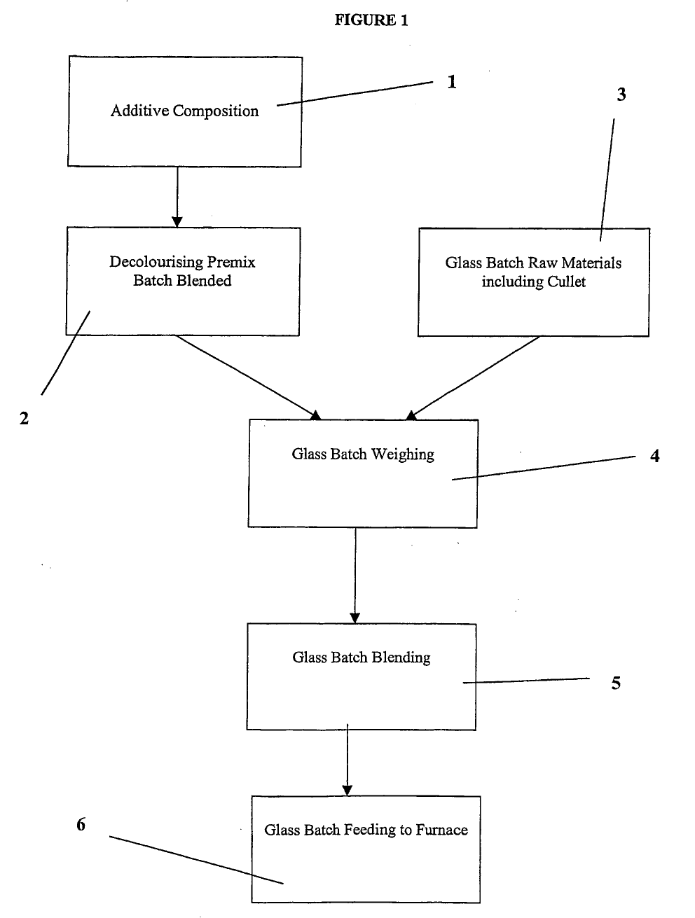

The additive compositions of the present invention may be utilised in the manufacture of many different types of glass. The glass batch of the present invention may comprise one or more additive compositions according to the present invention. Preferably when two additive compositions are used one comprises selenium and the second comprises cobalt. A typical process for the manufacture of container glass is shown schematically in FIG. 1.

In this process the additive composition (1) is first prepared ready for introduction into the process. This additive composition may then if necessary be batch blended with other materials to form a decolourising premix (2). If the additive composition (1) already comprises all the required decolourising materials then the premix stage (2) may be omitted and the additive composition (1) may be introduced directly to the glass batch weighing stage (4). At the glass batch weighing stage (4) the additive composition (1) or the premix (2) are combined with the bulk glass raw materials (3) in the requisite proportions to obtain the required glass composition from the glass furnace. The weighed components are then transferred to a glass batch blending stage (5) where all the components are thoroughly blended prior to introduction to the glass furnace (6).

A large variety of glasses with different chemical and physical properties can be made by a suitable adjustment to compositions used in their manufacture. The main constituent of most commercial glasses is sand. Sand is formulated with other chemicals for ease of processing and in order to achieve the desired properties in the final glass product. The addition of sodium carbonate (Na₂CO₃), known as soda ash, in a quantity to produce a fused mixture of 75% silica (SiO₂) and 25% of sodium oxide (Na₂O), will reduce the temperature of fusion to about 800° C. However, a glass of this composition is water-soluble and is known as water glass. In order to give the glass stability, other chemicals like calcium oxide (CaO) and magnesium oxide (MgO) are needed. The raw materials used for introducing CaO and MgO are their carbonates CaCO₃ (limestone) and MgCO₃ (dolomite), which when subjected to high temperatures give off carbon dioxide leaving the oxides in the glass.

An important class of glass is container glass. This is typically derived from a soda-lime silica glass with a typical composition by weight of SiO₂ 74%, Na₂O 14%, CaO 11%, and Al₂O₃ 1%. For certain container glasses where clarity and colour are important further chemical additives are introduced into the process to aid in colour/clarity control. It is preferred that the additive composition of the present invention is used in the manufacture of glasses, which require the addition of selenium and/or cobalt, and especially container glass.

The majority of commercial glasses used for the manufacture of container or flat glass are based on compositions that fall within the ranges identified in Table 4.

The raw materials within the composition are carefully weighed and thoroughly mixed, as consistency of composition is important. In addition glass cullet may be added to the composition; from 10 to 70% or 10 to 80% of the composition may be glass cullet.

Examples of suitable container glass batch formulations, which may be used in the glass manufacturing process of the present invention, are provided in Tables 2 and 3. Typical ranges of components for these container glass batches are provided in Table 4.

Flat glass is similar in composition to container glass except that it contains a higher proportion of magnesium oxide. A typical flat glass composition by weight is SiO₂ 71%, Na₂O 16%, CaO 9%, Al₂O₃ 1% and MgO 3%.

Generally, in forming selenium containing glasses according to the present invention raw material components would most generally comprise components like sand, soda ash, dolomite, limestone, salt cake, rouge (for iron oxide colorant), a manganese containing compound, and selenium compound. The amounts and the particular materials employed would depend, however, on the particular glass being produced and selection would be within the skill of one in the art in view of the present disclosure.

The additive composition of the present invention may be used as a means of introducing trace elements and compounds into any glass. Most of the glasses produced commercially on a large scale may be classified into three main groups: soda-lime, lead and borosilicate, of which the first is by far the most common. However, the invention is also appropriate for the manufacture of specialist glasses, which require the introduction of trace inclusions or even relatively high levels of selenium and/or cobalt.

TABLE 2

| | | | | | | Nepheline | | | Norwegian | |
|---|---|---|---|---|---|---|---|---|---|---|
| Formulation | Sand | Soda Ash | Limestone | Dolomite | Saltcake | Syenite | Calumite | Carbon | Feldspar | Alumina |
| A | 1000 | 266.7 | 180.4 | 114.6 | 11.4 | 25.0 | 60.0 | | | |
| B | 1000 | 318.6 | 224.9 | | 10.5 | 19.9 | 70.6 | | | |
| C | 1000 | 310.4 | 224.4 | 39.6 | 11.7 | | 56.5 | | 41.3 | |
| D | 1000 | 293.3 | 290.0 | | 28.3 | 93.3 | | | | |
| E | 1000 | 318.6 | 224.9 | | 10.5 | 19.9 | 70.6 | | | |
| F | 1000 | 315.7 | 242.5 | 35.3 | 10.5 | | 56.9 | | 62.1 | |
| G | 1000 | 313.8 | 257.1 | 13.2 | 9.0 | 11.4 | 71.7 | | | |
| H | 1000 | 313.5 | 257.8 | 13.2 | 10.7 | 11.5 | 71.9 | 2.8 | | |
| I | 1000 | 266.7 | 180.4 | 114.6 | 11.4 | 25.0 | 60.0 | | | |
| J | 1000 | 320.5 | 300.4 | 50.6 | 8.2 | 7.7 | 71.8 | | | |
| K | 1000 | 301.4 | 237.1 | | 12.9 | 48.6 | 60.0 | | | |
| L | 1000 | 293.6 | 198.9 | 90.9 | 10.8 | 64.0 | 47.4 | | | |
| M | 1000 | 310.0 | 177.0 | 85.0 | 9.2 | | 68.0 | | | |
| N | 1000 | 311.3 | 222.7 | | 12.3 | 44.7 | 70.0 | | | |
| O | 1000 | 293.6 | 198.9 | 90.9 | 10.8 | 64.0 | 47.4 | | | |
| P | 1000 | 301.1 | 127.6 | 143.7 | 16.0 | | | | | 16.6 |
| Q | 1000 | 309.7 | 216.2 | 120.8 | 9.9 | 55.4 | | | | |
| R | 1000 | 307.7 | 259.6 | | 9.9 | | 44.2 | | 16.8 | |
| S | 1000 | 303.7 | 217.8 | 50.7 | 11.9 | 27.2 | 51.5 | 0.2 | 6.7 | 0.9 |

All Figures are weight in Kg

TABLE 3

| | | | | | | Nepheline | | | Norwegian | |
|---|---|---|---|---|---|---|---|---|---|---|
| Formulation | Sand | Soda Ash | Limestone | Dolomite | Saltcake | Syenite | Calumite | Carbon | Feldspar | Potash |
| A1 | 1000 | 312.9 | 265.9 | | 20.65 | | 61.29 | | | |
| B1 | 1000 | 278.7 | 191.5 | 53.99 | 10.38 | | 41.53 | | 12.87 | |
| C1 | 1000 | 301.1 | 133.3 | 134.97 | 10.38 | | 41.53 | | 47.76 | |
| D1 | 1000 | 282.4 | 191.9 | 56.89 | 10.38 | | 41.53 | | 16.61 | |
| E1 | 1000 | 303.2 | 240.5 | | 7.29 | 81.63 | 54.66 | | | |
| F1 | 1000 | 307.1 | 237.1 | | 13.46 | 39.58 | 60 | | | |
| G1 | 1000 | 308.3 | 237.1 | | 11.38 | 39.58 | 60 | | | |
| H1 | 1000 | 304.9 | 205.2 | 93.93 | 10.84 | 65.03 | 40.46 | | | |
| I1 | 1000 | 315.4 | 188.0 | 83.76 | 10.26 | | | | 17.09 | 52.14 |
| J1 | 1000 | 296.7 | 286.7 | | 11.67 | 70 | | 0.29 | | |
| K1 | 1000 | 309.8 | 296.8 | | 7.87 | 57.77 | | 0.29 | | |

All Figures are weight in Kg

TABLE 4

| Component of Glass Batch | Range in weight percent |
|---|---|
| Sand | 56 to 66 |
| SodaAsh | 16 to 20 |
| Limestone | 7 to 18 |
| Dolomite | 0 to 9 |
| Saltcake | 0.25 to 2 |
| Nepheline Syenite | 0 to 5.5 |
| Calumite | 0 to 4.5 |
| Carbon | 0 to 0.3 |
| Norwegian Feldspar | 0 to 4 |
| Aluminium | 0 to 17 |
| Potassium | 0 to 3.5 |

Lead glasses are based on the use of lead oxide instead of calcium oxide, and of potassium oxide instead of all or most of the sodium oxide in soda-lime glasses. The traditional English full lead crystal contains at least 30% lead oxide (PbO) but any glass containing at least 24% PbO can be legitimately described as lead crystal according to the relevant EEC directive. Glasses of the same type, but containing less than 24% PbO, are known simply as crystal glasses. Glasses with even higher lead oxide contents (typically 65%) may be used as radiation shielding glasses because of the well-known ability of lead to absorb gamma rays and other forms of harmful radiation.

Borosilicate glasses are composed mainly of silica (70-80%) and boric oxide (7-13%) with smaller amounts of the alkalis (sodium and potassium oxides) and aluminium oxide.

Silica glass or vitreous silica is of considerable technical importance. However, the fact that temperatures above 1500° C. are necessary in the melting makes the transparent variety (often known as fused quartz or quartz glass) expensive and difficult to produce. The less expensive alternative for many applications is fused silica, which is melted at somewhat lower temperatures; in this case small gas bubbles remain in the final product, which is therefore not transparent. Another substitute for vitreous silica can be produced by melting a suitable borosilicate glass and then heating it at around 600° C. until it separates into two phases. The alkali-borate phase may be leached out with acids, leaving a 96% silica phase with open pores of controllable size, which can be converted, into clear glass. Porous glasses of this kind, commonly known as Vycor, from the first commercial version produced by Corning Glass Works Ltd, may be used as membranes for filtration purposes and for certain biological applications.

Aluminosilicate glasses contain 20% aluminium oxide (alumina-Al₂O₃) often including calcium oxide, magnesium oxide and boric oxide in relatively small amounts, but with only very small amounts of soda or potash. They tend to require higher melting temperatures than borosilicate glasses and are difficult to work, but have the merit of being able to withstand high temperatures and having good resistance to thermal shock.

Alkali-barium silicate glasses contain small amounts of heavy oxides (lead, barium or strontium).

Borate glasses are a range of glasses, containing little or no silica that can be used for soldering glasses, metals or ceramics at relatively low temperatures. When used to solder other glasses, the solder glass needs to be fluid at temperatures (450°-550° C.) well below that at which the glass to be sealed will deform. Some solder glasses do not crystallise or denitrify during the soldering process and thus the mating surfaces can be reset or separated; these are usually lead borate glasses containing 60-90% PbO with relatively small amounts of silica and alumina to improve the chemical durability. Another group consists of glasses that are converted partly into crystalline materials when the soldering temperature is reached, in which case the joints can be separated only by dissolving the layer of solder by chemical means. Such denitrifying solder glasses are characterised by continuing up to about 25% zinc oxide.

Glasses of a slightly different composition (zinc-silicoborate glasses) may also be used for protecting silicon semi-conductor components against chemical attack and mechanical damage. Such glasses must contain no alkalis (which can influence the semi-conducting properties of the silicon) and should be compatible with silicon in terms of thermal expansion. These materials, known as passivation glasses, have assumed considerable importance with the progress made in microelectronics technology in recent years that has made the concept of the “silicon chip” familiar to all.

Phosphate are known as semi-conducing oxide glasses and are used particularly in the construction of secondary electron multipliers. Typically they consist of mixtures of vanadium pentoxide (V₂O₅) and phosphorous pentoxide (P₂O₅). Chalcogenide glasses offer similar semi conductor effects and can be made without the presence of oxygen (non-oxide glasses). These may be composed of one or more elements of the sulphur group in the Periodic Table combined with arsenic, antimony, germanium and/or the halide (fluorine, chlorine, bromine, iodine).

Other glasses include optical glasses. Glasses with high dispersion relative to refractive index are called flint glasses while those with relatively low dispersions are called crown glasses. Typically flint glasses are lead-alkali-silicate compositions whereas crown glasses are soda-lime glasses. The substitution of other oxides permits considerable variations to be achieved. Thus barium crown (barium borosilicate), barium flint (barium lead silicate), borosilicate crown (sodium borosilicate) and crown flint (calcium lead-silicate) are all widely used. Phosphorous and the rare earths, especially lanthanum, may also be valuable ingredients in some optical glass compositions. The inclusion of transition elements (copper, titanium, vanadium, chromium, manganese, iron, cobalt or nickel) in glass produces strong absorption bands in the ultra violet part of the spectrum as well as broad bands in the visible and infra-red, enabling a series of colour filters and glasses with modified transmission properties in the ultra-violet and infra-red to be produced.

The use of rare earths has less effect on colour but it is of particular significance in the manufacture of laser glasses, most of which contain neodymium. The neodymium ions in the glass, when stimulated, emit radiation at a particular wavelength (1.06 um) and this is transformed into high-intensity coherent optical data, and for various measurement functions in industry.

Other glasses are the photochromic glasses, which include in their composition silver halide crystals produced by adding silver salts and compounds of fluoride, chlorine or bromine (the halides) to the base-glass (normally borosilicate). Controlled thermal treatment during and after melting causes extremely small phase separations to occur and these are responsible for the reversible darkening effect.

A further class of glasses are the sealing glasses, which may be used for sealing to tungsten, in making incandescent and discharge lamps, borosilicate alkaline earths-aluminous silicate glasses, are suitable. Sodium borosilicate glasses may be used for sealing to molybdenum and the iron-nickel-cobalt (Fernico) alloys are frequently employed as a substitute, the amount of sodium oxide permissible depending on the degree of electrical resistance required. With glasses designed to seal to Kovar alloy, relatively high contents of boric oxide (approximately 20%) are needed to keep the transformation temperature low and usually the preferred alkali is potassium oxide so as to ensure high electrical insulation.

Other glasses which may be manufactured according to the process of the present invention include architectural glasses and automobile glasses such as grey glasses, which typically have a composition by weight of SiO₂ 68 to 75%, Al₂O₃ O to 5%, CaO 5 to 15%, MgO O to 10%, Na₂O 10 to 18%, and K₂O O to 5%.

In addition, the colouring components of the grey glass composition consist essentially of: 0.9 to 1.9 wt. % total iron oxide as Fe₂O₃, 0.10 to 1.0 wt. % manganese oxide as MnO₂; 0.002 to 0.025 wt. % cobalt oxide as Co, and 0.0010 to 0.0060 wt. % selenium as Se, and 0 to 1.0 wt. % titanium oxide as TiO₂. The glass may also include tramp materials, which sometimes enter the glass with raw materials or as a result of changeover of one glass composition to another in a glass furnace. For example, this would include up to about 0.005 wt. % nickel oxide as NiO.

The manganese compound is employed to provide in the glass an amount of 0.10 to 1.0 wt % manganese oxide based on MnO₂, more preferably being 0.15 to 0.8 wt. %, most preferably being 0.15 or 0.20 to 0.60 MnO₂. This manganese compound colorant can be added to the batch glass components in a variety of forms, for example, but not limited to, MnO₂, Mn₃O₄, MnO, MnCO₃, MnSO₄, MnF₂, MnCl2, etc. Preferably it is most desirable to use the manganese oxide or manganese carbonate compounds in the batch. As would be appreciated, a mixture of such compounds may also be employed. In the glass composition, this colorant is generally present in the Mn⁺² and Mn⁺³ state, although it may additionally be present in other states such as Mn⁺⁴.

Manganese oxide when added to the glass batch materials replaces a portion of the selenium decolourant/colorant and in the specified amounts retains the selenium by acting as an oxidiser. It is preferred that manganese oxide is included in the additive composition of the present invention.

The grey glass composition also includes selenium as an essential ingredient for the grey colour because selenium has a maximum absorption about 500 nanometers and also combines with iron oxide to form an iron-selenium complex with a stronger absorption peak at about 490 nanometers. Manganese oxide in the Mn⁺³ form also has an absorption peak about 490 nanometers so that manganese oxide can partially replace selenium in the composition and provide the absorption needed for the grey colour of the glass. Selenium can be added to the grey glass in a variety of manners including: the elemental metal and in any compound form such as sodium selenite, barium selenite, selenium oxide, sodium selenate, etc. As indicated above it is preferably introduced as the selenite and more preferably zinc or sodium selenite.

Another application of the additive composition of the present invention is in the manufacture of glass ceramics. An essential feature of glass structure is that it does not contain crystals. However, by deliberately stimulating crystal growth in appropriate glasses it is possible to produce a range of materials with a controlled amount of crystallisation so that they can combine many of the best features of ceramics and glass. Some of these “glass ceramics” formed typically from lithium aluminosilicate glasses, are extremely resistant to thermal stock and have found several applications where this property if important, including cooker hobs, cooking ware, windows for gas or coal fires, mirror substrates for astronomical telescopes and missile nose cones.

The invention will now be further described with reference to the following examples, which are illustrative of but not limiting to the invention.

### EXAMPLES

### Example 1

Preparation Zinc Selenite Additive Composition

A mixture of Polysorbate 20 (Tween 20®) 1 part was dispersed in polyethyleneglycol 300 10 parts to form a surfactant composition. Calcium carbonate particulate carrier of carbonaceous calcium carbonate of nominal particle size of 2 mm, 98.5 wt % CaCO₃, and less than 0.09 wt % Fe as Fe₂O₃ (Trucal 6® supplied by Tilcon Ltd) (36.76 g) was added to a glass beaker. The surfactant composition (1 g) was added to the calcium carbonate in the beaker with stirring until an even liquid mixture was obtained. Then zinc selenite (41 wt % Se) (12 g) was added to the liquid mixture in stages with mixing until a uniform granule began to form. Finally the granule was finished by the drop wise addition of technical white oil (0.25 g) with mixing until a fully formed dry granule was produced.

The finished additive composition (granule) contained 9.84% w/w selenium.

### Example 2

Preparation of Cobalt II Oxide Additive Composition

A mixture of Polysorbate 20 (Tween 20®) 1 part was dispersed in polyethyleneglycol 300 10 parts to form a surfactant composition. Calcium carbonate particulate carrier (Trucal 6®) (40.50 g) was added to a glass beaker. The surfactant composition (1 g) was added to the calcium carbonate in the beaker with stirring until an even liquid mixture was obtained. Then cobalt U oxide (72 wt % Co) (7 g) was added to the liquid mixture in stages with mixing until a uniform black granule began to form. Finally the granule was finished by the drop wise addition of technical white oil (0.25 g) with mixing until a fully formed dry granule was produced. The finished additive composition (granule) contained 10% w/w cobalt.

### Example 3

Preparation of Se 1% Formulation

The following ingredients and process were utilised to manufacture the additive

| | CONTENT IN FINISHED |
|---|---|
| INGREDIENT | PRODUCT % W/W |
| Sodium selenite (min. 99.0%) | 2.272 |
| Poly ethylene glycol 300 | 2.008 |
| Polyoxyethylene 20 sorbitan | 0.201 |
| monolaurate | |
| Amorphous precipitated silica | 0.291 |
| Calcium carbonate granule | 95.228 |

The method for 1000 kg batch included the following steps.

In a horizontal ribbon blade solids mixer:
1. Switch on the mixer.
2. Add approximately half of the required calcium carbonate.
3. Add the sodium selenite.
4. Mix for 5 minutes.
5. Add the remaining calcium carbonate granule.
6. Mix for 5 minutes.
7. Spray the liquid mixture.
8. Mix for 5 minutes.
9. Add the silica
10. Mix for 3 minutes
Discharge the mixer.

### Example 4

Preparation of Mn containing additives

The following ingredients and process were utilised to manufacture a number of Mn containing additives

(a) 13% Mn

| | CONTENT IN FINISHED |
|---|---|
| INGREDIENT | PRODUCT % W/W |
| CaMg Carbonate | 76.5 |
| Poly ethylene glycol 300 | 3.5 |
| Polyoxyethylene 20 sorbitan monolaurate | |
| Mixture (10p:1p) | |
| MnO | 20 |

(b) 26% Mn

| | CONTENT IN FINISHED |
|---|---|
| INGREDIENT | PRODUCT % W/W |
| CaMg Carbonate | 53 |
| Poly ethylene glycol 300 | 7 |
| Polyoxyethylene 20 sorbitan monolaurate | |
| Mixture (10p:1p) | |
| MnO | 40 |

(C) 19.5% Mn

| | CONTENT IN FINISHED |
|---|---|
| INGREDIENT | PRODUCT % W/W |
| CaMg Carbonate | 64 |
| Poly ethylene glycol 300 | 6 |
| Polyoxyethylene 20 sorbitan monolaurate | |
| Mixture (10p:1p) | |
| MnO | 30 |

Method (for 1000 kg batch)

In a horizontal ribbon blade solids mixer:
1. Switch on the mixer.
2. Add approximately half of the required CaMg Carbonate
3. Add the MnO
4. Mix for 5 minutes.
5. Add the remaining CaMgcarbonate
6. Mix for 5 minutes.
7. Spray the liquid mixture.
8. Mix for 5 minutes.
9. Discharge the mixer.

### Example 5

Preparation of Cobalt containing additive.

| INGREDIENT | Weight of Ingredients (g) |
|---|---|
| Ca Carbonate P10 | 20600 |
| Poly ethylene glycol 300 | 625 |
| Polyoxyethylene 20 sorbitan monolaurate | |
| Mixture (10p:1p) | |
| Cobalt Oxide | 3525 |
| White Oil | 250 |

Briefly, the P10 was mixed for 2 min and then the Polyethyleneglycol 300/Polyoxyethylene 20 sorbitan monolaurate, mixture was added and mixing continued for a further 15 min. The cobalt oxide was then added and mixing continued for a further 15 minutes. Finally the white oil was added and mixing was continued for a further 20 minutes to form the final additive composition. This composition contained 10 wt % cobalt.

### Example 6

Preparation of a selenium containing composition

| INGREDIENT | Weight of Ingredients (g) |
|---|---|
| Ca Carbonate P10 | 17625 |
| Poly ethylene glycol 300 | 1000 |
| Polyoxyethylene 20 sorbitan monolaurate | |
| Mixture (10p:1p) | |
| Zinc Selinite Type II | 6250 |
| White Oil | 125 |

Briefly, the P10 was mixed for 2 min and then the Polyethyleneglycol 300/Polyoxyethylene 20 sorbitan monolaurate, mixture was added and mixing continued for a further 15 min. The zinc selenite was then added and mixing continued for a further 15 minutes. Finally the white oil was added and mixing was continued for a further 30 minutes to form the final additive composition. This composition contained 10 wt % selenium.

Preparation of Glass Batches

A number of glass batch formulations were formulated for evaluation of the additive compositions of Examples 1 to 3; the glass batch formulations are provided in Table 5.

TABLE 6

| | Sand | Soda Ash | Limestone | Saltcake | Syenite | Calumite | Selenium | Cobalt | Cullet | TOTAL |
|---|---|---|---|---|---|---|---|---|---|---|
| Typical Batch | 1000.00 | 307.08 | 237.08 | 13.46 | 39.58 | 60.00 | 0.050000 | 0.002583 | | 1657.00 |
| 25 kg Batch Only | 15.09 | 4.63 | 3.58 | 0.20 | 0.60 | 0.91 | 0.000754 | 0.000039 | 0.00 | 25.00 |
| 250 kg Batch only | 150.85 | 46.32 | 35.76 | 2.03 | 5.97 | 9.05 | 0.007543 | 0.000390 | 0.00 | 250.00 |
| 25 kg Total Batch + Cullet | 11.31 | 3.47 | 2.68 | 0.15 | 0.45 | 0.68 | 0.000566 | 0.000029 | 6.25 | 25.00 |
| 250 kg Total Batch + Cullet | 113.14 | 34.74 | 26.82 | 1.52 | 4.48 | 6.79 | 0.005657 | 0.000292 | 62.50 | 250.00 |

All Weights are in Kg

1. A particulate glass additive composition comprising at least one particulate carrier and, deposited on the surface of the carrier or carriers, at least one additive material in combination with a matrix which comprises at least one surface-active agent and/or organic film forming material.

2. A composition as claimed in claim 1, wherein the carrier is inorganic.

3. A composition as claimed in claim 2, wherein the inorganic carrier is calcium carbonate.

4. A composition as claimed in claim 1, wherein the glass additive material is selenium or a selenium containing compound or a mixture of selenium and selenium containing compound.

5. A composition as claimed in claim 4, wherein the selenium containing compound is a selenite, selenide, selenate.

6. A composition according to claim 4, wherein the selenium containing compound is a selenite.

7. A composition as claimed in claim 4, wherein the selenite is zinc or sodium selenite.

8. A composition according to claim 1, wherein the glass additive material comprises a manganese and or a cobalt containing compound.

9. A composition as claimed in claim 1, wherein the quantity of glass additive material is between 1 and 80% by weight with respect to the carrier.

10. A composition as claimed in claim 1, wherein the surface active agent is one or more of monoesters of propyleneglycol and of the food fatty acids, acetic, lactic, citric, tartaric and monoacetyltartaric esters of the mono and diglycerides of food fatty acids, glycerin polyethyleneglycol ricinoleate, polyethyleneglycol esters of soybean oil fatty acids, sorbitan monostearate, sorbitan tristearate, sorbitan monolaurate, sorbitan monooleate, sorbitan monopalmitate, propyleneglycol alginate and their mixtures with polyethyleneglycol and/or with propyleneglycol and/or with glycerin.

11. A composition as claimed in claim 1, wherein the organic film forming material is one or more of methylcellulose, hydroxypropylcellulose, methylhydroxypropylcellulose, hydroxypropylmethylcellulose (HPMC), cellulose acetate phthalate (CAP), carboxymethylcellulose, ethylcellulose, acetylcellulose, Hydroxypropylethylcellulose (HPEC), mixtures of microcrystalline cellulose and carrageenan, polyvinylpyrrolidone, polyvinyl alcohol, polyvinylacetate, gum arabic, substances of wax type such as polyethyleneglycols, higher alcohols, higher fatty acids and hydrogenated fatty substances, xantham gum, dextrins and maltodextrins.

12. A process for the manufacture of a particulate glass additive composition which process comprises contacting at least one particulate carrier with at least one glass additive material to provide a coated carrier followed by contact of the coated carrier with one or more surface active agents and/or one or more organic film forming materials to form a matrix.

13. A process for the manufacture of a particulate glass additive composition which process comprises contacting at least one particulate carrier with at least one surface active agent and/or at least one organic film forming material to form a mixture and introducing into the mixture at least one glass additive material to form a additive composition.

14. A process for the manufacture of a glass additive composition which process comprises mixing at least one glass additive with at least one surface active agent and/or at least one organic film forming material to form an additive/surfactant/film former mixture and contacting the resulting mixture with at least one particulate carrier.

15. A process as claimed in claim 12 wherein any one or more process steps are repeated.

16. A process as claimed in claim 12, wherein a non-ionic surface active agent is used in a quantity of between 0.5 and 10% by weight with respect to the combined weight of carrier and additive material.

17. A process as claimed in claim 12, wherein said surface active agents are monoesters of propyleneglycol and of the food fatty acids, acetic, lactic, citric, tartaric and monoacetyltartaric esters of the mono and diglycerides of food fatty acids, glycerin polyethyleneglycol ricinoleate, polyethyleneglycol esters of soybean oil fatty acids, sorbitan monostearate, sorbitan tristearate, sorbitan monolaurate, sorbitan monooleate, sorbitan monopalmitate, propyleneglycol alginate and their mixtures with polyethyleneglycol and/or with propyleneglycol and/or with glycerin.

18. A process as claimed in claim 12, wherein said organic film forming material is one or more of methylcellulose, hydroxypropylcellulose, methylhydroxypropylcellulose, hydroxypropylmethylcellulose (HPMC), cellulose acetate phthalate (CAP), carboxymethylcellulose, ethylcellulose, acetylcellulose, Hydroxypropylethylcellulose (HPEC), mixtures of microcrystalline cellulose and carrageenan, polyvinylpyrrolidone, polyvinyl alcohol, polyvinylacetate, gum arabic, substances of wax type such as polyethyleneglycols, higher alcohols, higher fatty acids and hydrogenated fatty substances, xantham gum, dextrins and maltodextrins.

19. A process for the manufacture of glass which comprises introducing at least one glass additive composition according to claim 1, into glass forming components as a glass batch before addition to a melting furnace or via introduction into the melting furnace during molten glass formation.

20. A process as claimed in claim 19, wherein the glass batch is for making container or architectural or automotive glass.

21. A process for retarding the volatilization of selenium used as a decolorant in preparing a container glass composition comprising including at least one glass additive composition according to claim 1, during melt processing of the glass composition, said method comprising the steps of: admixing and melting together sand, soda ash, dolomite, limestone, salt cake, a cobalt containing compound, and the glass additive composition, in quantities sufficient to form said container glass composition having a base glass composition comprising by weight: 68 to 75% SiO2, 10 to 18% Na20, 5 to 15% CaO, 0 to 10% Al₂O₃, and 0 to 5%,K20, 0.002 to 0.025 wt. % cobalt oxide as Co, 0.0010 to 0.0060 wt. % selenium as Se oxides or polyseleneides.

22. A selenium and cobalt containing glass obtainable by the process of claim 12.

23. A glass batch premix which comprises one or more additive compositions according to claim 1, and in addition one or more components required for the manufacture of glass.

24. A process for the manufacture of glass which comprises introducing at least one glass additive composition manufactured by the process of claim 12, into glass forming components as a glass batch before addition to a melting furnace or via introduction into the melting furnace during molten glass formation.

25. A process as claimed in claim 24, wherein the glass batch is for making container or architectural or automotive glass.

26. A process for retarding the volatilization of selenium used as a decolorant in preparing a container glass composition comprising including at least one glass additive composition manufactured by the process of claim 12, during melt processing of the glass composition, said method comprising the steps of: admixing and melting together sand, soda ash, dolomite, limestone, salt cake, a cobalt containing compound, and the glass additive composition, in quantities sufficient to form said container glass composition having a base glass composition comprising by weight: 68 to 75% SiO2, 10 to 18% Na20, 5 tol 5% CaO, 0 to 10% Al₂O₃, and 0 to 5%,K20, 0.002 to 0.025 wt. % cobalt oxide as Co, 0.0010 to 0.0060 wt. % selenium as Se oxides or polyseleneides.

27. A glass batch premix which comprises one or more additive compositions manufactured by the process of claim 12, and in addition one or more components required for the manufacture of glass.
